(19) United States
(12) Patent Application Publication
(10) Pub. No.: US 2020/0355560 A1
(43) Pub. Date: Nov. 12, 2020

(54) SENSOR DEVICE

(71) Applicant: DENSO CORPORATION, Kariya-city (JP)

(72) Inventor: Satoru SHIMIZU, Kariya-city (JP)

(21) Appl. No.: 16/936,927

(22) Filed: Jul. 23, 2020

Related U.S. Application Data
(63) Continuation of application No. PCT/JP2018/044245, filed on Nov. 30, 2018.

(30) Foreign Application Priority Data
Feb. 5, 2018 (JP) 2018-018285

(51) Int. Cl. G01K 7/16; G01K 1/20; G01K 7/01; G01L 19/04; G01L 9/00; G01F 1/34

(52) U.S. Cl. CPC G01K 7/16; G01K 1/20; G01F 1/34; G01L 19/04; G01L 9/00; G01K 7/01

(57) ABSTRACT

A sensor device includes a sensor element and a circuit chip. The sensor element detects a temperature of a measurement object to be measured and outputs a temperature signal according to the temperature of the measurement object. The circuit chip receives the temperature signal and performs signal processing. The circuit chip includes a detection element that detects a temperature of the circuit chip.

### CROSS REFERENCE TO RELATED APPLICATIONS

The present application is a continuation application of International Patent Application No. PCT/JP2018/044245 filed on Nov. 30, 2018, which designated the U.S. and claims the benefit of priority from Japanese Patent Application No. 2018-018285 filed on Feb. 5, 2018. The entire disclosures of all of the above applications are incorporated herein by reference.

### TECHNICAL FIELD

The present disclosure relates to a sensor device for detecting the temperature of a measurement object to be measured.

### BACKGROUND

For example, a sensor device includes a sensor element for detecting the temperature of a measurement object and a circuit chip for performing signal processing of a temperature signal of the sensor element. The sensor element and the circuit chip are disposed apart from each other as independent devices.

### SUMMARY

The present disclosure describes a sensor device including a sensor element and a circuit chip. The sensor element detects a temperature of a measurement object to be measured and outputs a temperature signal according to the temperature of the measurement object. The circuit chip receives the temperature signal and performs signal processing.

### BRIEF DESCRIPTION OF DRAWINGS

Objects, features, and advantages of the present disclosure will become more apparent from the following detailed description made with reference to the accompanying drawings, in which:

FIG. 1 is a sectional view of a sensor device according to a first embodiment;

FIG. 2 is a block diagram of a sensor chip and a circuit chip;

FIG. 3 is a diagram showing a specific circuit of the sensor chip and the circuit chip;

FIG. 4 is a diagram showing a heat circuit corresponding to the configuration shown in FIG. 1;

FIG. 5 is a diagram showing the correlation between a sensor error and the temperature difference between the circuit chip and a sensor element;

FIG. 6 is a diagram showing an error correction value with respect to the temperature difference between the circuit chip and the sensor element;

FIG. 7 is a diagram showing a corrected sensor error;

FIG. 8 is a diagram showing a sensor error due to the influence of an ambient temperature and a corrected sensor error;

FIG. 9 is a diagram showing a sensor error due to the influence of heat generation of the circuit chip and a corrected sensor error;

FIG. 10 is a sectional view showing the difference in flow velocity between a measurement object flowing outside a housing and a measurement object flowing inside the housing; and

FIG. 11 is a diagram showing a sensor error due to the influence of the response delay of the sensor element and a corrected sensor error.

### DETAILED DESCRIPTION

In a sensor device; if a sensor element for detecting the temperature of a measurement object and a circuit chip for processing a signal output from the sensor element are disposed apart from each other, the influence of heat on the sensor element and the influence of heat on the circuit chip differ from each other. If heat is conducted from the circuit chip through the sensor element to the measurement object; a sensor error caused by a temperature difference between the measurement object and the sensor element might occur.

The present disclosure provides a sensor device that can reduce a sensor error caused by a temperature difference between a measurement object and a sensor element.

According to an aspect of the present disclosure, a sensor device includes a sensor element and a circuit chip. The sensor element detects a temperature of a measurement object to be measured and outputs a temperature signal according to the temperature of the measurement object. The circuit chip receives the temperature signal and performs signal processing.

If the temperature signal includes a sensor error, which is caused by a temperature difference between the measurement object and the sensor element, a temperature difference between the sensor element and the circuit chip according to the sensor error occurs.

The circuit chip thus has a detection element that detects a temperature of the circuit chip. The circuit chip corrects the temperature signal in accordance with a temperature difference between the temperature of the circuit chip detected by the detection element and the temperature of the measurement object detected by the sensor element, and outputs a corrected temperature signal to an outside.

In such a configuration, the sensor error can be corrected in accordance with the temperature difference by utilizing the correlation between the sensor error and the temperature difference between the circuit chip and the sensor element. Therefore, the sensor error caused by the temperature difference between the measurement object and the sensor element can be reduced.

Hereinafter, a plurality of embodiments for carrying out the present disclosure will be described with reference to the accompanying drawings. In the following embodiments, parts corresponding to items described in the preceding embodiments are denoted by the same reference numerals, and redundant description may be omitted. In each embodiment, when only a part of a configuration is described, another embodiment previously described can be employed for other parts of the configuration. Further, it is possible to not only combine parts whose combination is possible as specified in the embodiments but also partially combine embodiments even though not specified herein as long as the combination poses no problem.

### First Embodiment

Hereinafter, a first embodiment of the present disclosure will be described with reference to the accompanying drawings. A sensor device according to the present embodiment is configured to be able to detect the temperature of a measurement object to be measured. The sensor device is fixed to, for example, a pipe as an attaching object, and detects the temperature of the measurement object within the pipe. The measurement object is, for example, a medium such as oil. The measurement object may be another medium like a liquid such as a refrigerant or a gas.

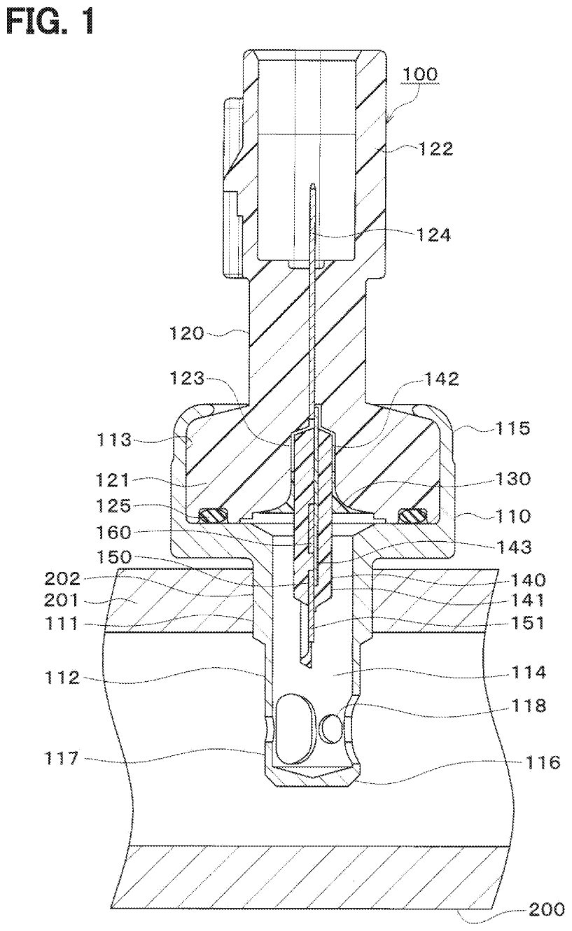

As shown in FIG. 1, a sensor device 100 includes a housing 110, a molded resin part 120, a potting resin part 130, a mold resin part 140, and a sensor chip 150.

The housing 110 is a hollow case formed by processing a metallic material such as SUS by cutting or the like. A male screw part 111 which can be screwed to a pipe 200 as an attaching object is formed on the outer peripheral surface of the housing 110.

The housing 110 has a medium introduction part 112 on one end side, and has an opening part 113 on the other end side. The medium introduction part 112 is a tubular part where a medium introduction hole 114 is formed. The medium introduction hole 114 is in communication with the opening part 113. The opening part 113 of the housing 110 is configured to be enclosed by a peripheral wall 115. A part of the medium introduction part 112 in the housing 110 is fixed to a through screw hole 202 provided in a thick part 201 of the pipe 200. Thereby, a distal end portion 116 of the medium introduction part 112 is positioned inside the pipe 200. For example, the pipe 200 is filled with oil as the measurement object.

Further, the housing 110 has a diffuser 117 at the distal end portion 116 of the medium introduction part 112. The diffuser 117 is a part that projects in the hollow part of the pipe 200 from the thick part 201 of the pipe 200, and is provided with a plurality of apertures 118. Further, the diffuser 117 serves to introduce the measurement object into the medium introduction hole 114 through any of the plurality of apertures 118.

The molded resin part 120 is a part that provides a connector for electrically connecting the sensor device 100 with an external device. The molded resin part 120 is formed of a resin material such as PPS, and is formed with a fixing part 121 fixed to the opening part 113 of the housing 110 on one end side and with a connector part 122 on the other end side. The fixing part 121 has a recessed portion 123 recessed toward the connector part 122.

Further, in the molded resin part 120, a terminal 124 is integrally molded by insert molding. One end of the terminal 124 is sealed in the fixing part 121, and the other end of the terminal 124 is insert-molded in the molded resin part 120 so as to be exposed inside the connector part 122. The one end of the terminal 124 is connected to an electrical component of the mold resin part 140 by housing a portion of the mold resin part 140 in the recessed portion 123.

Further, the molded resin part 120 is fixed in such a manner that the end part of the peripheral wall 115 of the housing 110 is crimped to be pressed against the fixing part 121, with the fixing part 121 fitted in the opening part 113 of the housing 110 through an O-ring 125.

The potting resin part 130 is formed of a resin material such as epoxy resin, and filled in a gap between the recessed portion 123 of the molded resin part 120 and the mold resin part 140. The potting resin part 130 seals and protects the portion of the mold resin part 140, the joint part of the terminal 124, and the like from the oil as the measurement object.

The mold resin part 140 is a component for holding the sensor chip 150. The mold resin part 140 has a columnar shape having one end part 141 and the other end part 142 opposite to the one end part 141. The mold resin part 140 holds the sensor chip 150 adjacent to the one end part 141.

Further, the mold resin part 140 seals a portion of a lead frame 143 and a circuit chip 160. The lead frame 143 is a base component on which the sensor chip 150 and the circuit chip 160 are mounted.

A distal end portion of the other end of the lead frame 143 is exposed from the other end part 142 of the mold resin part 140, and connected to the one end of the terminal 124. The lead frame 143 may be divided into a plurality of parts. In such a case, an electrical connection can be made by a bonding wire. The lead frame 143 and the terminal 124 may also be connected by the bonding wire.

The circuit chip 160 is an IC chip formed with a semiconductor integrated circuit such as a memory. The circuit chip 160 is formed using a semiconductor substrate. The circuit chip 160 supplies power to the sensor chip 150, and performs the signal processing of a temperature signal output from the sensor chip 150 based on a preset signal processing value. The signal processing value is an adjustment value, for example, for amplifying, calculating, and correcting the signal value of the temperature signal. The circuit chip 160 is electrically connected to the sensor chip 150 through the lead frame 143 by a bonding wire (not shown).

The sensor chip 150 is an electronic component for detecting the temperature of the measurement object. The sensor chip 150 is mounted on the lead frame 143, for example, by silver paste. The sensor chip 150 is composed of a plate-shaped laminated substrate configured by laminating a plurality of layers (not shown). As for the plurality of layers, a plurality of wafers are laminated as a wafer level package, and processed in a semiconductor process or the like, and then diced for each sensor chip 150.

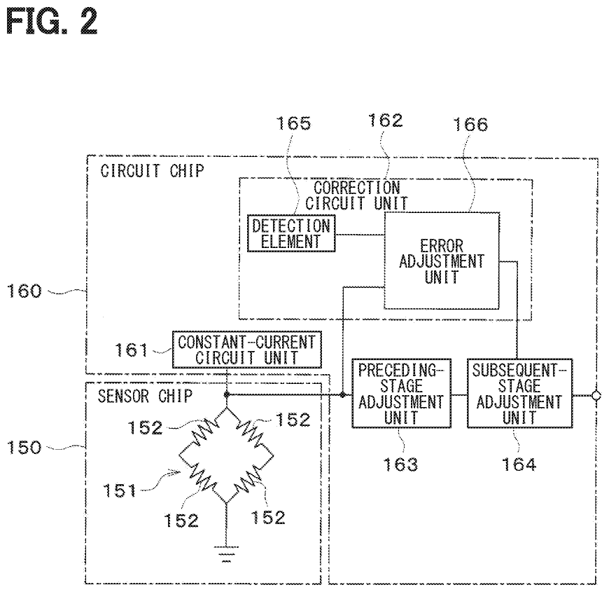

As shown in FIG. 2, the sensor chip 150 has a sensor element 151 for detecting the temperature of the measurement object. The sensor element 151 is a sensing unit for outputting the temperature signal according to the temperature of the measurement object. The sensor element 151 is made of a plurality of piezoresistance elements 152 whose resistance values change in accordance with the temperature of the measurement object. Each piezoresistance element 152 is a diffused resistor formed by ion implantation into a semiconductor layer among the plurality of layers of the laminated substrate.

The semiconductor layer is, for example, an N-type single-crystal silicon layer. Each piezoresistance element 152 is formed as a P⁺-type region or a P-type region. That is, each piezoresistance element 152 is configured as a P-type semiconductor. Further, other electrical elements such as a wire and a pad are also formed in the sensor chip 150.

The piezoresistance elements 152 are electrically connected so as to form a Wheatstone bridge circuit. The Wheatstone bridge circuit is supplied with constant-current power from the circuit chip 160. Thereby, it is possible to detect, as the temperature signal, a voltage according to the temperature of the measurement object, utilizing the piezoresistance effect of each piezoresistance element 152.

That is, the sensor chip 150 detects the resistance change of the plurality of piezoresistance elements 152 according to heat that the laminated substrate receives from the measurement object, as the bridge voltage of the Wheatstone bridge circuit. Then, the sensor chip 150 outputs the bridge voltage as the temperature signal. The sensor chip 150 is sealed in the one end part 141 of the mold resin part 140 so that a part corresponding to a temperature detection unit is exposed.

On the other hand, as shown in FIG. 2, the circuit chip 160 has a constant-current circuit unit 161, a correction circuit unit 162, a preceding-stage adjustment unit 163, and a subsequent-stage adjustment unit 164. The constant-current circuit unit 161 is a circuit unit for supplying constant-current power to the sensor element 151 of the sensor chip 150.

The correction circuit unit 162 is a circuit unit for generating a correction value for correcting a sensor error included in the temperature signal. The correction circuit unit 162 has a detection element 165 and an error adjustment unit 166. The detection element 165 is an element for detecting the temperature of the circuit chip 160. The detection element 165 is a temperature-sensitive resistor whose resistance value changes in accordance with the temperature. The detection element 165 is incorporated in the circuit chip 160.

For example, an N-type single-crystal silicon substrate is adopted for the circuit chip 160. The detection element 165 is formed on the single-crystal silicon substrate as a P⁺-type region or a P-type region. That is, the detection element 165 is configured as a P-type semiconductor. Further, the detection element 165 is a resistor having a positive resistance temperature coefficient. The detection element 165 is the same resistance element as the piezoresistance element 152. Further, the sensor element 151 and the detection element 165 are provided by resistance elements whose impurity concentrations are adjusted so that the respective resistance temperature coefficients are equal to each other.

The error adjustment unit 166 receives the detection signal of the detection element 165 and the temperature signal of the sensor chip 150, and generates a correction signal for correcting a sensor error included in the temperature signal, based on these signals. The error adjustment unit 166 outputs the correction signal to the subsequent-stage adjustment unit 164.

The preceding-stage adjustment unit 163 is connected to the sensor element 151 of the sensor chip 150. The preceding-stage adjustment unit 163 is a circuit unit for performing the sensitivity adjustment of the temperature signal received from the sensor element 151. The subsequent-stage adjustment unit 164 is connected to the correction circuit unit 162 and the output side of the preceding-stage adjustment unit 163. The subsequent-stage adjustment unit 164 is a circuit unit for performing offset adjustment for the sensitivity-adjusted temperature signal and correcting the sensor error based on the correction signal.

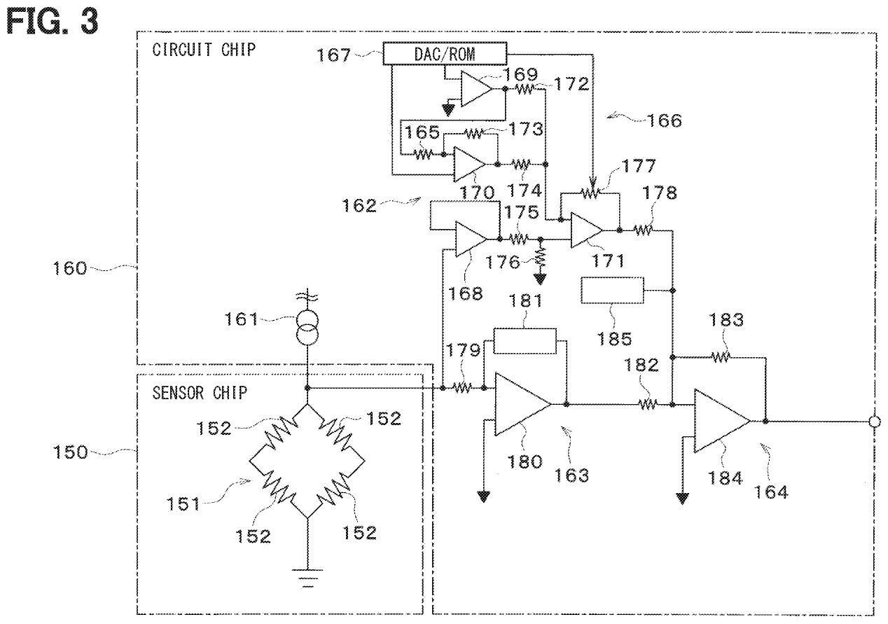

More specifically, as shown in FIG. 3, the correction circuit unit 162 has a DAC/ROM unit 167, a plurality of operational amplifiers 168, 169, 170, 171, and a plurality of resistors 172, 173, 174, 175, 176, 177, 178. These elements constitute a voltage follower, an amplifier circuit, and the like.

The DAC/ROM unit 167 stores information such as reference potentials and a resistance value. The DAC/ROM unit 167 converts the stored information into analog signals, and adjusts the reference potentials of the operational amplifiers 169, 170 and the resistance value of the resistor 177.

The correction circuit unit 162 adjusts the detection signal of the detection element 165 by the circuit configuration of the above elements. The detection signal is a signal whose signal value is proportional to the temperature. The correction circuit unit 162 has the function of aligning the gradient and offset value of the signal value of the detection signal with the gradient and offset value of the signal value of the temperature signal. This is to prevent the temperature signal from being corrected if there is no temperature difference between the sensor element 151 and the circuit chip 160.

The preceding-stage adjustment unit 163 is a circuit unit for performing the sensitivity adjustment of the temperature signal. The preceding-stage adjustment unit 163 is a differential amplifier circuit unit having a resistor 179, an operational amplifier 180, and a sensitivity adjustment circuit unit 181. The preceding-stage adjustment unit 163 corrects and outputs the sensitivity of the temperature signal in accordance with a sensitivity correction value stored in the sensitivity adjustment circuit unit 181.

The subsequent-stage adjustment unit 164 is a circuit unit for performing the offset adjustment of the temperature signal. The subsequent-stage adjustment unit 164 is a differential amplifier circuit unit having resistors 182, 183, an operational amplifier 184, and an offset adjustment circuit unit 185. The subsequent-stage adjustment unit 164 corrects and outputs the offset of the sensitivity-adjusted temperature signal in accordance with an offset correction value stored in the offset adjustment circuit unit 185. The above is the entire configuration of the sensor device 100.

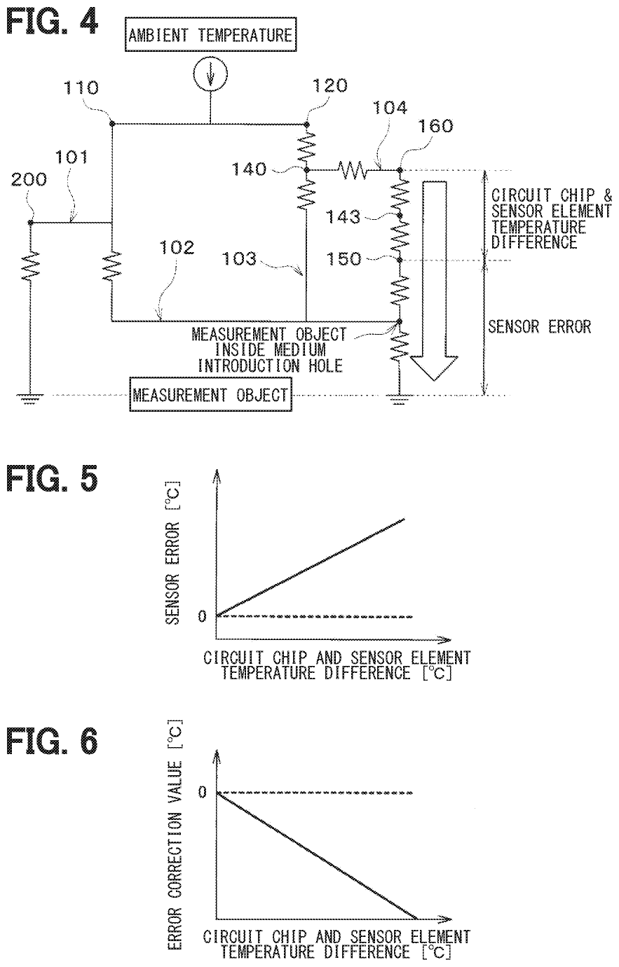

Next, the sensor error included in the temperature signal will be described. As shown in FIG. 4, there are a plurality of paths through which heat of the ambient temperature reaches the measurement object within the pipe 200.

A first path 101 is a path through which the heat of the ambient temperature reaches the measurement object within the pipe 200 through the housing 110 and the pipe 200. A second path 102 is a path through which the heat of the ambient temperature reaches the measurement object within the pipe 200 through the housing 110 and the measurement object positioned in the medium introduction hole 114. A third path 103 is a path through which the heat of the ambient temperature reaches the measurement object within the pipe 200 through the molded resin part 120, the mold resin part 140, and the measurement object positioned in the medium introduction hole 114.

A fourth path 104 is a path through which the heat of the ambient temperature reaches the measurement object within the pipe 200 through the molded resin part 120, the mold resin part 140, the circuit chip 160, the lead frame 143, the sensor chip 150, and the measurement object positioned in the medium introduction hole 114.

The inventors of the present disclosure have focused on heat flux flowing in a stated order through the circuit chip 160, the lead frame 143, the sensor chip 150, and the measurement object positioned in the medium introduction hole 114 to the measurement object within the pipe 200, in the fourth path 104. The temperature of the sensor chip 150 is equal to the temperature of the sensor element 151. Therefore, in the following, the temperature of the sensor chip 150 is the temperature of the sensor element 151.

By the heat flux, a temperature difference occurs between the measurement object within the pipe 200 and the sensor element 151. Therefore, the temperature measured by the sensor element 151 includes the sensor error. The sensor error is a component caused by the temperature difference between the measurement object within the pipe 200 and the sensor element 151. Further, a temperature difference occurs between the circuit chip 160 and the sensor element 151.

Based on the occurrence of the temperature difference, the inventors of the present disclosure have found the correlation between the temperature difference between the circuit chip 160 and the sensor element 151 and the temperature difference between the sensor element 151 and the measurement object within the pipe 200.

More specifically, as shown in FIG. 5, the temperature difference between the sensor element 151 and the measurement object within the pipe 200 increases as the temperature difference between the circuit chip 160 and the sensor element 151 increases. That is, the sensor error increases at a constant increase rate with respect to the temperature difference between the circuit chip 160 and the sensor element 151. In other words, if the temperature signal includes the sensor error, the temperature difference between the sensor element 151 and the circuit chip 160 according to the sensor error occurs.

Based on the above correlation, the inventors of the present disclosure have thought that the sensor error included in the temperature signal can be corrected based on the temperature difference between the circuit chip 160 and the sensor element 151. Therefore, in the present embodiment, the sensor device 100 has the configuration shown in FIGS. 1 to 3.

Next, a method for correcting the sensor error included in the temperature signal will be described. First, the sensor chip 150 outputs the bridge voltage of the sensor element 151 as the temperature signal. The sensor error might be included in the temperature signal.

The circuit chip 160 receives the temperature signal from the sensor chip 150, and provides the temperature signal to the correction circuit unit 162 and the preceding-stage adjustment unit 163. The preceding-stage adjustment unit 163 corrects the sensitivity of the temperature signal in accordance with the sensitivity correction value stored in the sensitivity adjustment circuit unit 181, and outputs the sensitivity-corrected temperature signal to the subsequent-stage adjustment unit 164.

The detection element 165 of the correction circuit unit 162 detects the temperature of the circuit chip 160 to obtain the detection signal. The error adjustment unit 166 of the correction circuit unit 162 generates an error correction value for correcting the sensor error included in the temperature signal, based on the temperature signal and the detection signal.

Therefore, by the circuit around the operational amplifiers 169, 170, the error adjustment unit 166 aligns the constant increase rate of the signal value of the detection signal with respect to the temperature and the offset value of the signal value of the detection signal with the constant increase rate of the signal value of the temperature signal with respect to the temperature and the offset value of the signal value of the temperature signal, respectively. Thereby, the temperature signal is not corrected if there is no temperature difference occurs between the circuit chip 160 and the sensor element 151.

Then, by the circuit around the operational amplifier 171, the error adjustment unit 166 generates an error correction value that decreases at a constant decrease rate which is the same rate as the constant increase rate of the signal value of the detection signal with respect to the temperature difference between the temperature of the detection signal and the temperature of the temperature signal.

As shown in FIG. 6, the error correction value decreases at the constant decrease rate with respect to the temperature difference between the circuit chip 160 and the sensor element 151. The gradient of the error correction value is obtained by reversing the polarity of the gradient of the detection signal, that is, the gradient of the temperature signal. The correction circuit unit 162 outputs the signal corresponding to the error correction value to the subsequent-stage adjustment unit 164.

The subsequent-stage adjustment unit 164 corrects the offset of the temperature signal in accordance with the offset correction value stored in the offset adjustment circuit unit 185. Further, the subsequent-stage adjustment unit 164 corrects the sensor error included in the temperature signal by adding the error correction value to the temperature signal.

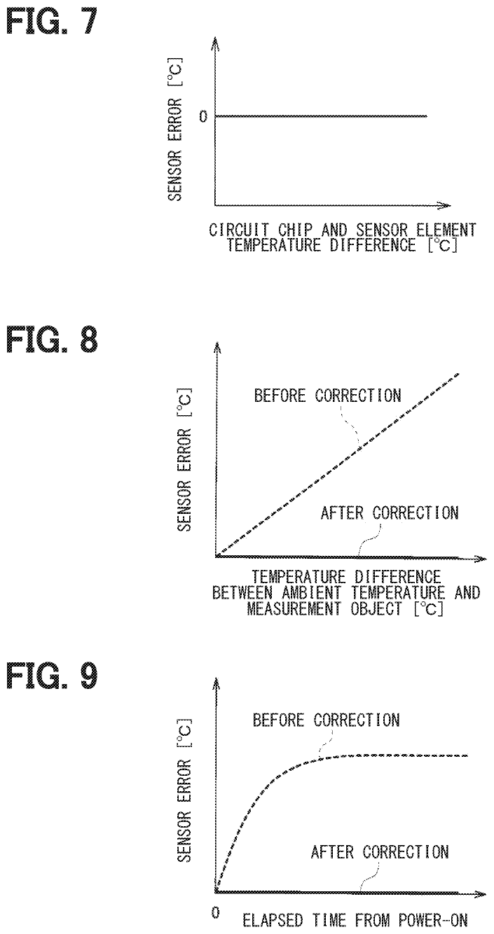

As shown in FIG. 7, since the error correction value is added to the temperature signal, the sensor error with respect to the temperature difference between the circuit chip 160 and the sensor element 151 is canceled. Therefore, if the sensor error is included in the temperature signal, the temperature signal is corrected by the error correction value.

On the other hand, if the sensor error is not included in the temperature signal, there is no temperature difference between the circuit chip 160 and the sensor element 151. In this case, the sensor error shown in FIG. 5 is zero. Accordingly, the error correction value shown in FIG. 6 is zero. Therefore, the subsequent-stage adjustment unit 164 adds the error correction value of zero to the temperature signal. This inhibits the temperature signal from being corrected in spite of no occurrence of the temperature difference between the circuit chip 160 and the sensor element 151.

Thus, the circuit chip 160 corrects the temperature signal in accordance with the temperature difference between the temperature of the circuit chip 160 detected by the detection element 165 and the temperature of the measurement object detected by the sensor element 151. Further, the circuit chip 160 outputs the corrected temperature signal to the outside.

As described above, it is possible to correct the sensor error included in the temperature signal in accordance with the temperature difference by utilizing the correlation between the sensor error and the temperature difference between the circuit chip 160 and the sensor element 151. Therefore, it is possible to reduce the sensor error caused by the temperature difference between the measurement object and the sensor element 151.

That is, it is possible to measure the temperature of the measurement object in a situation where the temperature difference among the circuit chip 160, the sensor element 151, inside of the medium introduction hole 114, and inside of the pipe 200 is prone to occur. In such a case, the sensor chip 150 is positioned at a position corresponding to the thick part 201 instead of the central part of the pipe 200, but due to the utilization of the temperature difference among the parts, it is possible to measure the temperature of the measurement object. In particular, this is suitable for measurement in the case where the temperature of the measurement object is an ultra-high temperature or an ultra-low temperature and in a special case where the measurement object is a strong acid or the like.

For example, the sensor error may occur due to the influence of the ambient temperature. This is a case where the heat of the ambient temperature is conducted to the sensor element 151 via the second path 102 and the third path 103 shown in FIG. 4. In this case, as shown in FIG. 8, the sensor error increases as the temperature difference between the ambient temperature and the temperature of the measurement object increases. However, the circuit chip 160 generates the error correction value, corrects the temperature signal by the error correction value, and thereby can reduce the sensor error to almost zero.

Further, the sensor error may occur due to the influence of heat generation of the circuit chip 160. This is a case where the heat of the circuit chip 160 is conducted through the lead frame 143 to the sensor element 151 via the fourth path 104 shown in FIG. 4. In this case, as shown in FIG. 9, the sensor error increases with rise in the temperature of the circuit chip 160 after electric power to the circuit chip 160 is turned on. The circuit chip 160 is configured with a semiconductor device, and is therefore largely influenced by heat generation. After the lapse of a certain time from the power-on of the circuit chip 160, the temperature of the circuit chip 160 becomes a constant value, and the sensor error also becomes a constant value.

In such a case as well, since the generation of the error correction value is started immediately after the power-on of the circuit chip 160, it is possible to correct the sensor error immediately after the power-on of the circuit chip 160. Therefore, it is possible to reduce the sensor error to almost zero, regardless of the heat generation of the circuit chip 160.

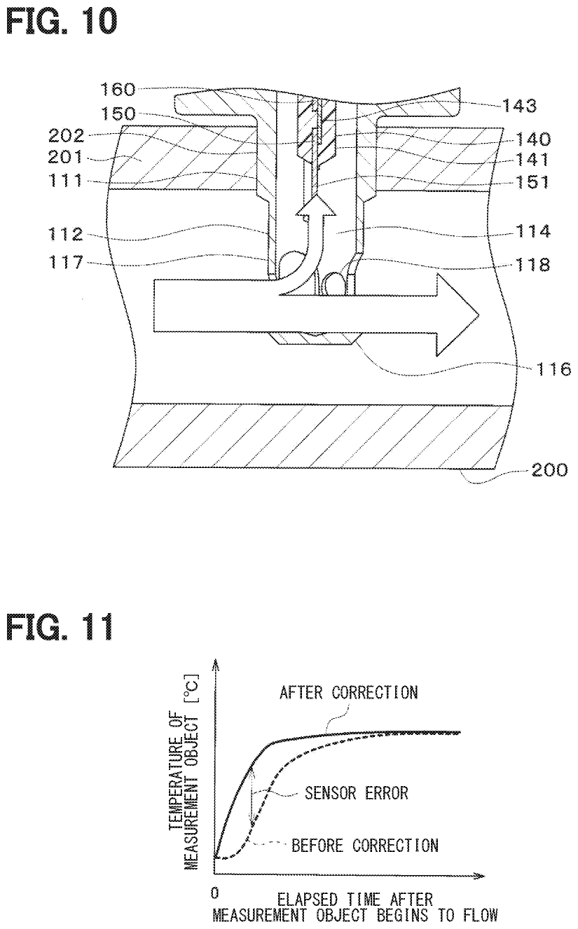

Further, as shown in FIG. 10, the flow velocity of the measurement object flowing within the pipe 200 is slower in the inside of the housing 110 than in the outside thereof. Therefore, the sensor error may occur due to the delay of the response of the sensor element 151 relative to the measurement object. In this case, since it takes time for the measurement object to reach the temperature detection part of the sensor chip 150, there occurs a temperature difference between the temperature of the measurement object within the pipe 200 and the measurement temperature at the time of being measured during transition when the measurement object starts to flow, as shown in FIG. 11. That is, the temperature detected by the sensor element 151 is lower than the temperature of the measurement object within the pipe 200.

In such a case as well, the circuit chip 160 corrects the temperature signal based on the error correction value, and thereby can acquire the temperature of the measurement object within the pipe 200. In particular, it is possible to improve the accuracy of the measurement temperature during the transition when the measurement object starts to flow.

As a modification, for example, a thermistor may be adopted as the element for detecting the temperature of the measurement object.

As another modification, the circuit chip 160 may perform processing for adjusting the gain of the temperature signal or processing for weighting the temperature signal and thereby correct the sensor error. The gain and the weight value are set with respect to the temperature difference between the circuit chip 160 and the sensor element 151. Thus, a correction method other than the method of adding the error correction value to the temperature signal may be adopted.

As another modification, the circuit chip 160 may have the function of estimating the ambient temperature of an environment where the sensor device 100 is disposed. The circuit chip 160 acquires three temperatures of the correct temperature of the measurement object obtained by the correction of the temperature signal, the temperature of the sensor element 151 indicated by the temperature signal, and the temperature of the circuit chip 160 indicated by the detection element 165. Then, the circuit chip 160 estimates the ambient temperature from the three temperatures.

The piezoresistance element 152 according to the present embodiment corresponds to a resistance element.

### Second Embodiment

In the present embodiment, parts different from those in the first embodiment will be described. In the present embodiment, the sensor element 151 detects the pressure of the measurement object. Therefore, the sensor chip 150 has a diaphragm (not shown).

For example, the sensor chip 150 is provided by a laminated substrate formed of five layers. For example, of the five layers, a first layer, a second layer, and a third layer form an SOI substrate, and a fourth layer and a fifth layer form a cap substrate. The second layer and the third layer are configured as a thin-walled diaphragm. The third layer is a semiconductor layer such as silicone, and a plurality of piezoresistance elements 152 are formed thereon.

The fourth layer and the fifth layer have a recessed part where a part corresponding to the sensing area of the diaphragm is recessed. The recessed part provides a space part enclosed by laminating the third layer; the fourth layer, and the fifth layer. The space part is, for example, a vacuum chamber. Therefore, the pressure measured by the sensor chip 150 is absolute pressure.

The piezoresistance elements 152 are used to detect both the pressure and the temperature. Since the piezoresistance elements 152 forms the Wheatstone bridge circuit as described above, the change of the midpoint voltage of the Wheatstone bridge circuit due to the resistance change of the piezoresistance elements 152 according to the distortion of the diaphragm is outputted as a pressure signal. The piezoresistance elements 152 may be formed separately for temperature detection and for pressure detection on the sensor chip 150.

The circuit chip 160 receives the pressure signal from the sensor chip 150, and corrects the pressure value of the measurement object, based on the corrected temperature signal. Since the piezoresistance element 152 has the resistance value changing in accordance with the temperature, it is possible to improve the accuracy of the pressure value by the temperature correction of the pressure value. Thereby, the sensor device 100 can output the temperature-corrected pressure value to the outside.

As a modification, the sensor chip 150 may detect at least one of the flow rate, viscosity, humidity, and acceleration of the measurement object in addition to the pressure, as a physical quantity different from the temperature of the measurement object. That is, the sensor chip 150 has a sensing unit for detecting the flow rate, the viscosity, the humidity, or the acceleration, besides the temperature detection unit. The circuit chip 160 corrects the physical quantity different from the temperature of the measurement object, based on the corrected temperature signal.

The present disclosure is not limited to the above embodiments, and various changes and modifications can be made as follows without departing from the scope and spirit of the present disclosure.

For example, the attaching object of the sensor device 100 is not limited to the pipe 200, and the sensor device 100 may be fixed to an attaching object such as a container. In this case, the sensor device 100 detects the temperature of the measurement object within the container.

The electrical connection component between the circuit chip 160 and the sensor chip 150 is not limited to the lead frame 143, For example, the circuit chip 160 and the sensor chip 150 may be mounted on a printed circuit board.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A sensor device comprising:
a sensor element that detects a temperature of a measurement object to be measured and outputs a temperature signal according to the temperature of the measurement object; and
a circuit chip that receives the temperature signal and performs signal processing, wherein
the temperature signal includes a sensor error caused by a temperature difference between the measurement object and the sensor element,
when the temperature signal includes the sensor error, a temperature difference between the sensor element and the circuit chip according to the sensor error occurs, and
the circuit chip includes a detection element that detects a temperature of the circuit chip, and the circuit chip corrects the temperature signal in accordance with a temperature difference between the temperature of the circuit chip detected by the detection element and the temperature of the measurement object detected by the sensor element, and outputs a corrected temperature signal to an outside.

2. The sensor device according to claim 1, wherein
the sensor error increases at a constant increase rate with respect to the temperature difference between the circuit chip and the sensor element, and
the circuit chip generates an error correction value, and corrects the sensor error by adding the error correction value to the temperature signal, the error correction value decreasing at a constant decrease rate, which is the same rate as the constant increase rate, with respect to the temperature difference between the circuit chip and the sensor element.

3. The sensor device according to claim 1, wherein
the sensor chip detects at least one of a pressure, a flow rate, a viscosity, a humidity, and an acceleration of the measurement object, in addition to the temperature of the measurement object, as a physical quantity different from the temperature of the measurement object.

4. The sensor device according to claim 3, wherein
the circuit chip corrects the physical quantity different from the temperature of the measurement object, based on the corrected temperature signal.

5. The sensor device according to claim 1, wherein
the sensor element and the detection element are each provided by a resistance element formed of a P-type semiconductor whose resistance value changes in accordance with the temperature of the measurement object.

6. The sensor device according to claim 5, wherein
the sensor element and the detection element have positive resistance temperature coefficients, and have impurity concentrations adjusted so that the respective resistance temperature coefficients are equal to each other.
